(19) United States
(12) Patent Application Publication
(10) Pub. No.: US 2026/0166784 A1
(43) Pub. Date: Jun. 18, 2026

(54) PRESS MOLDING DIE, PRESS DEVICE, METHOD FOR MANUFACTURING SHAPED ARTICLE, AND METHOD FOR MANUFACTURING MOLDED ARTICLE

(71) Applicant: Panasonic Intellectual Property Management Co., Ltd., Osaka (JP)

(72) Inventors: HIROSHI MORIOKA, Osaka (JP); TAKASHI MORIMOTO, Osaka (JP); TOMONORI SUGIYAMA, Osaka (JP); YUNAN O, Osaka (JP)

(21) Appl. No.: 19/532,398

(22) Filed: Feb. 6, 2026

Related U.S. Application Data
(63) Continuation of application No. PCT/JP2024/031688, filed on Sep. 4, 2024.

(30) Foreign Application Priority Data
Sep. 21, 2023 (JP) 2023-155930

(51) Int. Cl. B29C 43/02; B29C 43/42; B29C 45/14; B29C 69/02

(52) U.S. Cl. CPC B29C 43/02; B29C 43/42; B29C 45/14336; B29C 69/02; B29C 2045/14868

(57) ABSTRACT

A press molding die is a press molding die of at least one of a punch and a die, and includes a pressing mechanism that supports a workpiece at a position where the workpiece is not shaped during press processing, and presses the workpiece in a pressurizing direction.

### TECHNICAL FIELD

The present disclosure relates to a press molding die, a press device, a method for manufacturing a shaped article, and a method for manufacturing a molded article.

### BACKGROUND ART

In recent years, in exterior parts of home appliances, in-vehicle interior parts, and the like, there is an increasing need for decoration methods having a wide range of design expressions and high-quality designs due to diversification of customer orientation. As one of the decoration methods, there is an insert molding method in which a decorative material is positioned and fixed in an injection molding die and integrated with an injected resin. By using this insert molding method, for example, it is possible to obtain a molded article using a decorative material made of a sheet, such as a veneer obtained by thinly slicing wood, or a decorative film printed on a thick substrate.

On the other hand, when insert molding the decorative material formed of these sheets, it is common to need a mechanism for fixing the decorative material to the injection molding die, such as forming a positioning hole in a margin of an outer periphery of the product on the decorative material side and providing a pin for setting the positioning hole on the injection molding die side.

Note that the insert molding method defined in the present disclosure refers to a method of forming an entire product appearance surface with the decorative material, and includes a shape in which the decorative material is wound from the product appearance surface to a product back side depending on product specifications.

### CITATION LIST

### Patent Literature

PTL 1: Unexamined Japanese Patent Publication No. 2019-181907

### SUMMARY OF THE INVENTION

In FIG. 6 of PTL 1, in order to obtain veneer/resin laminated structure housing 40 having a three-dimensional shape, in step II, veneer 1 is disposed between female die 10 and male die 11 and press molding is performed to deform flat veneer 1 into a three-dimensional shape, however, in a case where a side surface is not a shape having no curvature as in FIG. 1 of PTL, since deformation such as a wrinkle occurs in veneer 1 in step II, veneer/resin laminated structure housing 40 having a beautiful appearance cannot be obtained. That is, there is a certain restriction on the shape. Since the wrinkle generated in a pressing step is retained even in an injection molding step, the beautiful appearance cannot be obtained.

An object of the present disclosure is to provide a press molding die in which the wrinkle is less likely to occur.

A press molding die according to the present disclosure is a press molding die of at least one of a punch and a die, and includes a support pressing mechanism that supports a workpiece at a position where the workpiece is not shaped during press processing, and presses the workpiece in a pressurizing direction.

With the press molding die according to the present disclosure, in a pressing step, a laminate is disposed between a side pad and a punch die and is restrained to a bottom dead center, thereby preventing the wrinkle in the pressing step. This makes it possible to provide a decorative component using a laminate that widens shape restriction without generating the wrinkle as compared with a conventional example.

### BRIEF DESCRIPTION OF THE DRAWINGS

FIG. 1 is a schematic sectional view illustrating a sectional structure of a decorative component that is a molded article according to a first exemplary embodiment.

FIG. 2 is a perspective view obtained by imaging by analysis an appearance of an intermediate component and a shaped article obtained in each of steps of the method for manufacturing the shaped article.

FIG. 3 is a schematic sectional view illustrating a thermocompression bonding step for obtaining a laminate which is a part of the decorative component of FIG. 1.

FIG. 4 is a plan view (a) and a sectional view (b) illustrating a trimming processing step for the laminate.

FIG. 5 is a schematic sectional view illustrating the steps of the method for manufacturing the shaped article using a press molding die according to the first exemplary embodiment.

FIG. 6 is a view illustrating a front view, a back view, and a plurality of side views of a laminate of the shaped article.

FIG. 7 is a plan view illustrating a front view of the press molding die including a die, a side pad, and a side pad drive mechanism in the method for manufacturing the shaped article of FIG. 2.

FIG. 8A is a schematic sectional view illustrating a method of driving the side pad using a spring of the press molding die according to the first exemplary embodiment.

FIG. 8B is a schematic sectional view illustrating the method of driving the side pad using the spring of the press molding die according to the first exemplary embodiment.

FIG. 8C is a schematic sectional view illustrating the method of driving the side pad using the spring of the press molding die according to the first exemplary embodiment.

FIG. 9A is a schematic sectional view illustrating a method of driving the side pad using the spring and a cylinder of the press molding die according to the first exemplary embodiment.

FIG. 9B is a schematic sectional view illustrating the method of driving the side pad using the spring and the cylinder of the press molding die according to the first exemplary embodiment.

FIG. 9C is a schematic sectional view illustrating the method of driving the side pad using the spring and the cylinder of the press molding die according to the first exemplary embodiment.

FIG. 10A is a schematic sectional view illustrating a shape and a position of the side pad in the press molding die according to a modification of the first exemplary embodiment.

FIG. 10B is a schematic sectional view illustrating the shape and the position of the side pad in the press molding die according to the modification of the first exemplary embodiment.

FIG. 10C is a schematic sectional view illustrating the shape and the position of the side pad in the press molding die according to the modification of the first exemplary embodiment.

FIG. 10D is a schematic sectional view illustrating the shape and the position of the side pad in the press molding die according to the modification of the first exemplary embodiment.

FIG. 11A is a schematic sectional view illustrating a sectional structure of a step of placing the laminate as the shaped article on a cavity die of insert molding that is an example of the method for manufacturing a molded body according to the first exemplary embodiment.

FIG. 11B is a schematic sectional view illustrating a sectional structure of a step of injecting an injection molding resin into a cavity defined between a rear surface of the laminate placed in the cavity die and a core die of the insert molding that is an example of the method for manufacturing the molded body according to the first exemplary embodiment.

FIG. 12 is a schematic sectional view illustrating a primary appearance surface and a secondary appearance surface which are normal appearance surfaces of the decorative component which is the molded article according to a second exemplary embodiment.

FIG. 13 is a schematic sectional view illustrating the steps of the method for manufacturing the shaped article using the press molding die according to the second exemplary embodiment.

FIG. 14A is a schematic sectional view illustrating the sectional structure of the step of placing the laminate as the shaped article on the cavity die of the insert molding that is the example of the method for manufacturing the molded body according to the second exemplary embodiment.

FIG. 14B is a schematic sectional view illustrating the sectional structure of the step of injecting the injection molding resin into the cavity defined between the rear surface of the laminate placed in the cavity die and the core die of the insert molding that is an example of the method for manufacturing the molded body according to the first exemplary embodiment.

FIG. 14C is a schematic sectional view illustrating the sectional structure of the molded article according to the second exemplary embodiment.

FIG. 15A is a schematic sectional view illustrating the method of driving the side pad of the press molding die according to the second exemplary embodiment.

FIG. 15B is a schematic sectional view illustrating the method of driving the side pad of the press molding die according to the second exemplary embodiment.

FIG. 15C is a schematic sectional view illustrating the method of driving the side pad of the press molding die according to the second exemplary embodiment.

FIG. 15D is a schematic sectional view illustrating the method of driving the side pad of the press molding die according to the second exemplary embodiment.

FIG. 15E is a schematic sectional view illustrating the method of driving the side pad of the press molding die according to the second exemplary embodiment.

FIG. 15F is a schematic sectional view illustrating the method of driving the side pad of the press molding die according to the second exemplary embodiment.

FIG. 15G is a schematic sectional view illustrating the method of driving the side pad of the press molding die according to the second exemplary embodiment.

### DESCRIPTION OF EMBODIMENT

A press molding die according to a first aspect is a press molding die of at least one of a punch and a die, and includes a support pressing mechanism that supports a workpiece at a position where the workpiece is not shaped during press processing, and presses the workpiece in a pressurizing direction.

The press molding die according to a second aspect may further include, in the first aspect, a side pressing mechanism that supports the workpiece from a direction perpendicular to the pressurizing direction along with deformation of the workpiece during press processing, retracts to a surface continuous with a surface of the press molding die in contact with the workpiece in accordance with progress of shaping, and shapes the workpiece.

The press molding die according to a third aspect may include, in the first or second aspect, a plurality of the pressing mechanisms.

In the press molding die according to a fourth aspect in the first or second aspect, the pressing mechanism may have an undercut forming function of forming an undercut in the workpiece.

A press molding die set including a punch and a die according to a fifth aspect includes the press molding die according to the first or second aspect.

A press device according to a sixth aspect includes the press molding die set according to the fifth aspect.

A method for manufacturing a shaped article according to a seventh aspect includes: a first step of placing a workpiece on a press molding die; and a second step of pressing the workpiece with the press molding die to form the workpiece into the shaped article, and in the second step, while supporting the workpiece at a position where the workpiece is not shaped and pressing the workpiece in a pressurizing direction, the workpiece is pressed to form the workpiece into the shaped article.

In the method for manufacturing the shaped article according to an eighth aspect in the seventh aspect, in the second step, the workpiece is supported from a direction perpendicular to the pressurizing direction along with deformation of the workpiece, and the workpiece may be shaped along a surface continuous with a surface of the press molding die in contact with the workpiece in accordance with progress of shaping.

The method for manufacturing the shaped article according to a ninth aspect may further include, in the seventh or eighth aspect, an undercut forming step of forming an undercut in the workpiece.

A method for manufacturing a molded article according to a tenth aspect includes: a step of placing the shaped article obtained by the method for manufacturing the shaped article according to the seventh or eighth aspect on a cavity die of an injection molding die including a cavity die and a core die, and clamping the cavity die and the core die; a step of allowing a resin to flow into a cavity defined between the shaped article placed on the cavity die and the core die; and a step of, after the resin is cured, opening the cavity die and the core die to take out a molded article made of the shaped article and the cured resin.

Hereinafter, the press molding die and the method for manufacturing the molded article using the die according to each exemplary embodiment of the present disclosure will be described with reference to the drawings.

### First Exemplary Embodiment

### <Method for Manufacturing Molded Article>

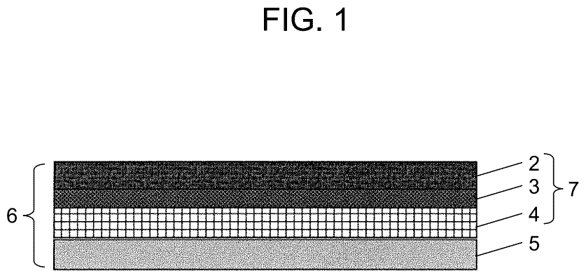

FIG. 1 is a schematic sectional view illustrating a sectional structure of decorative component 6 that is the molded article obtained in the present first exemplary embodiment.

As illustrated in FIG. 1, decorative component 6 as the molded article includes substrate resin 5 and laminate 7, and laminate 7 includes decorative layer 2, adhesive layer 3, and support layer 4.

### <Decorative Layer>

Decorative layer 2 is not limited as long as it is a commonly used decorative material such as fabric, natural wood, leather, and a decorative film.

A thickness of decorative layer 1 is not particularly limited depending on characteristics of the decorative material, but is preferably in a range of 0.1 mm to 3 mm. When the thickness of decorative layer 1 is less than 0.1 mm, handleability is deteriorated, and defects such as a wrinkle and a tear are likely to occur during processing. On the other hand, when the thickness of decorative layer 2 is more than 3 mm, hardness of the entire laminate increases, flexibility is deteriorated, and followability to a product shape is deteriorated.

### <Adhesive Layer>

Adhesive layer 3 has a role of bonding decorative layer 2 and support layer 4. Adhesive layer 3 is made of, for example, a resin such as a vinyl chloride-vinyl acetate-based copolymer, an olefin-based resin, a polyolefin-based resin, a urethane-based resin, or an acryl-based resin, and is formed in such a form that completely covers a surface of support layer 4. The material is not limited as long as decorative layer 2 and support layer 4 can be bonded to each other.

Adhesive layer 3 preferably has an average film thickness of 2 μm or more and 200 μm or less. If the thickness is less than 2 μm, peeling failure such as cohesive fracture may occur due to insufficient film strength of adhesive layer 3 itself. Furthermore, the adhesive thickness is also insufficient, and sufficient adhesive strength to decorative layer 2 and support layer 4 cannot be obtained. On the other hand, even when the thickness is larger than 200 μm, the adhesive strength is not affected, and rather, the manufacturing cost increases due to an increase in film thickness. The film thickness of 3 μm or more and 100 μm or less is more preferable in consideration of a balance between the film strength and adhesive strength and the production cost. A penetration membrane thickness of adhesive layer 3 to support layer 4 (due to an anchor effect) is preferably 5 μm or more. When the thickness is less than 5 μm, the adhesive strength to support layer 3 is insufficient, and interface peeling failure may occur. A process of forming adhesive layer 3 is not limited depending on the handling form.

When adhesive layer 3 is handled in a liquid state, adhesive layer 3 may be formed in advance on decorative layer 2 side or may be formed in advance on support layer 4 side, by using a known printing/coating process such as spray spraying, roll coater, or inkjet coating. Alternatively, when adhesive layer 3 is handled in a solid state such as a sheet, adhesive layer 3 may be bonded to decorative layer 2 in advance and then bonded to support layer 3. Alternatively, conversely, it may be bonded to support layer 4 in advance and then bonded to decorative layer 2. Further, decorative layer 2, adhesive layer 3, and support layer 4 may be bonded simultaneously. When adhesive layer 3 is formed in a form that completely covers the surface of support layer 4, followability to support layer 4 can be improved.

### <Support Layer>

Support layer 4 plays a role of improving the strength of laminate 7 itself by hot pressing, and holding laminate 7 in a predetermined processed shape. Since adhesive layer 3 is formed in a form that completely covers support layer 4, and decorative layer 2 is formed via adhesive layer 3, strength improvement of support layer 3 itself effectively acts on strength improvement and shape retention of laminate 7 itself.

A material, thickness, and the like of support layer 4 can be selected according to the application. Support layer 4 is obtained by, for example, forming a web by obliquely folding a fiber spun from a card spinning machine into a cross, and entangling the fiber by a needle punching machine to form a nonwoven fabric sheet. As the material, for example, polyester, polyethylene terephthalate, polypropylene, rayon, nylon, and vinylon can be selected. Support layer 4 may be made of two or more kinds of materials having different melting points or similar materials having different melting points. For example, when a fiber coated with polyethylene having a melting point lower than that of polyethylene terephthalate on a polyethylene terephthalate fiber is used, polyethylene terephthalate fibers in the nonwoven fabric sheet are impregnated with polyethylene by applying an arbitrary heat treatment after forming the nonwoven fabric sheet, and as a result, support layer 4 having high strength is obtained.

### <Outline of Method for Manufacturing Shaped Article>

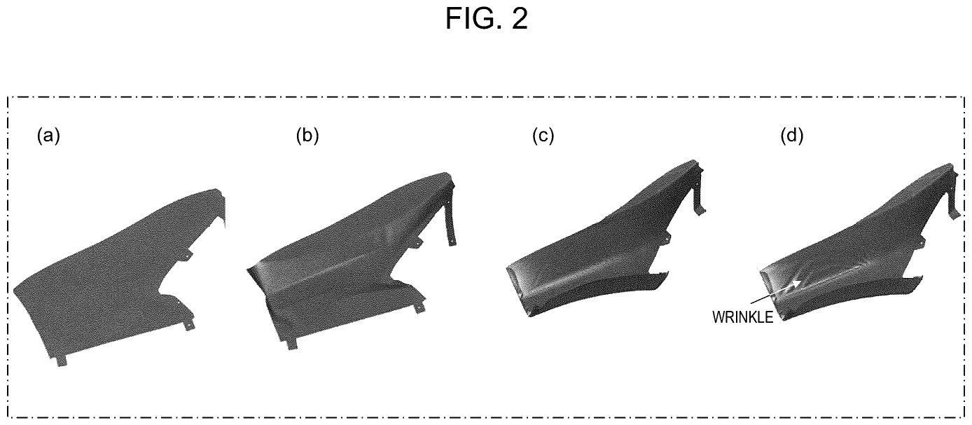

FIG. 2(a) to 2(d) are perspective views obtained by imaging by analysis an appearance of an intermediate component and the shaped article obtained in each step of the method for manufacturing the shaped article. FIG. 2(a) is a perspective view illustrating a planar laminate processed into a shape of the decorative component in a trimming step after the laminate is obtained by a thermocompression bonding step. FIG. 2(b) is a perspective view illustrating the intermediate component of the shaped article in a shaping (preform) step of pressurizing the laminate with the press molding die according to the first exemplary embodiment. FIG. 2(c) is a perspective view illustrating the shaped article having a decorative component shape after pressurization, following FIG. 2(b). In the shaping (preform) step using the press molding die according to the first exemplary embodiment, since the laminate is supported at a position where the laminate is not shaped, and the laminate is pressed in the pressurizing direction, the wrinkle is less likely to occur in the shaped article.

On the other hand, FIG. 2(d) is a perspective view of the shaped article obtained using a conventional press molding die. As illustrated in FIG. 2(d), in the shaped article obtained using the conventional press molding die, the wrinkle is generated on a surface of the laminate. This is considered that since an end portion is not pressed when the laminate is pressurized, and thus the laminate is pressurized and the surface of the laminate shaped into the decorative component shape is excessive and the wrinkle is formed.

Thereafter, in an injection molding step (not illustrated), the substrate resin is applied to the laminate having the decorative component shape obtained in the shaping (preform) step to obtain the decorative component. These will be described below.

### <Thermocompression Bonding Step>

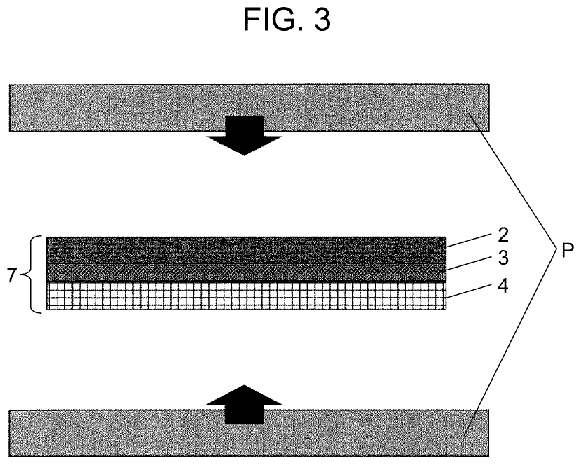

FIG. 3 is a schematic sectional view illustrating the thermocompression bonding step for obtaining laminate 7. Laminate 7 is formed by compression bonding using a thermocompression bonding device P that can apply heat and pressure. By applying heat and pressure, adhesive layer 3 disposed between decorative layer 2 and support layer 4 melts, and decorative layer 2 and support layer 4 are brought into close contact with each other, thereby obtaining laminate 7.

Examples of thermocompression bonding device P include known devices such as a general-purpose press device that applies pressure with upper and lower heated plates, a multi-stage press device, a vacuum laminator device, and a roll-to-roll press device. Laminate 7 manufactured by these devices is in a stiffer sheet state than when decorative layer 2 is used alone, so that the handleability during subsequent processing can be improved. At this time, in a case where support layer 4 described above includes two types of fibers, the strength of laminate 7 can be enhanced by adjusting temperature of the thermocompression bonding device to melt one fiber and impregnate the other fiber with the melted fiber.

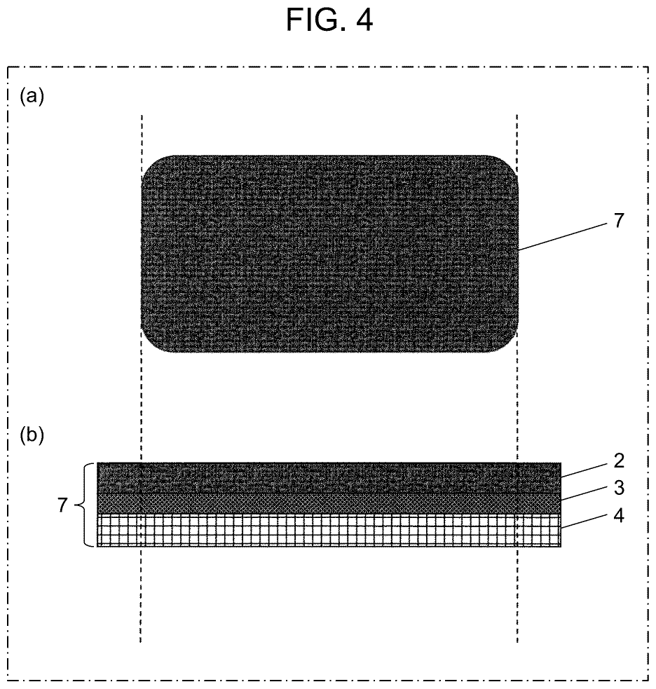

FIG. 4 is a plan view (a) and a sectional view (b) illustrating a trimming processing step of processing laminate 7 into a two-dimensional shape in consideration of irregularities and bending of the product shape. Examples of a trimming processing method include shape punching using a Thomson die, laser cutting, and hand cutting, but are not particularly limited as long as trimming into a predetermined product shape can be performed. In subsequent steps, the laminate is processed into a three-dimensional shape that matches the product shape. Therefore, if the laminate can be trimmed so that there is no excess part in the product shape, subsequent post-processing is unnecessary, and productivity is improved.

### <Press Molding Die>

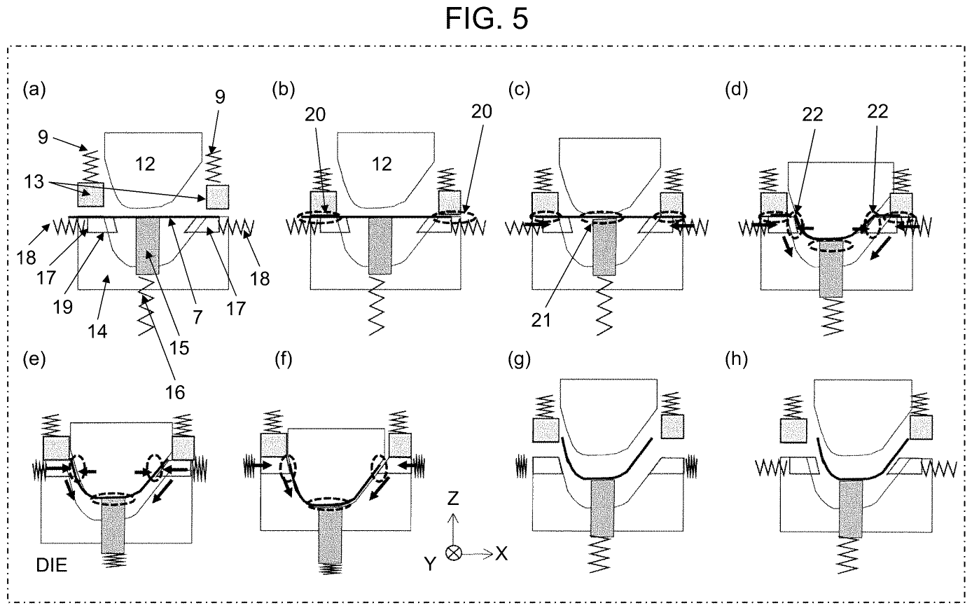

FIG. 5 is a schematic sectional view illustrating the steps of the method for manufacturing the shaped article using the press molding die according to the first exemplary embodiment. The press molding die according to the first exemplary embodiment will be described with reference to FIG. 5. Note that for the sake of convenience, a vertically upward direction is taken as a Z direction, a horizontal direction perpendicular to this is taken as an X direction from left to right on the paper, and a Y direction from front to back on the paper.

The press molding die according to the first exemplary embodiment is at least one press molding die of punch die 12 and die 14. In FIG. 5, the press molding die corresponds to die 14. The press molding die (die 14) includes stripper 13 and stripper drive mechanism 9 (support pressing mechanism) that support laminate 7 at a position where laminate (workpiece) 7 is not shaped during press processing, and press laminate 7 in the pressurizing direction (vertical direction: Z direction). In addition, this press molding die includes side pad 17 and side pad mechanism 18 (side pressing mechanism) that support laminate 7 from a direction (horizontal direction: X direction) perpendicular to the pressurizing direction along with the deformation of laminate 7 during press processing. As described above, stripper 13 and stripper drive mechanism 9 constitute the support pressing mechanism. Side pad 17 and side pad mechanism 18 constitute the side pressing mechanism.

Hereinafter, functions of the support pressing mechanism constituted by stripper 13 and stripper drive mechanism 9 and the side pressing mechanism constituted by side pad 17 and side pad drive mechanism 18, which are characteristics of the press molding die according to the first exemplary embodiment, will be described.

FIG. 5(a) is a schematic sectional view illustrating an initial state of the shaping (preform) step. The press molding die includes movable punch die 12, stripper 13, stripper drive mechanism 9, die 14, pad 15 provided in die 14, pad drive mechanism 16, side pad 17, and side pad drive mechanism 18.

Note that laminate 7 is supported from vertically below by pad 15 and pad drive mechanism 16.

Stripper drive mechanism 9, pad drive mechanism 16, and side pad drive mechanism 18 are provided to support, press, and restrain laminate 7 as punch die 12 operates. Stripper drive mechanism 9, pad drive mechanism 16, and side pad drive mechanism 18 are manufactured by, for example, a known drive method such as a metal spring, a gas spring, a hydraulic pump, and a pneumatic pump, and are selected according to the preform step such as a required pressure, cost, and control method. These drive mechanisms 9, 16, and 18 respectively have a role of driving stripper 13, pad 15, and side pad 17. These driving methods include known methods such as the metal spring, the gas spring, the hydraulic pump, and the pneumatic pump, and are selected according to the preform step such as the required pressure, cost, and control method. Note that projection allowance 19, which is a length of side pad 17 projecting from a surface of die 14, is a step between die 14 and side pad 17. Note that an upper surface of side pad 17 is flush with an upper surface of die 14.

In FIG. 5(b), punch die 12, stripper 13, and stripper drive mechanism 9 are moved, stripper 13 supports laminate 7 in the pressurizing direction (Z direction), and laminate 7 is pressed between stripper 13 and side pad 17 in the pressurizing direction (Z direction). That is, laminate 7 is restrained between stripper 13 and the upper surface of side pad 17, and laminate restraining portion A 20 is generated.

Note that laminate restraining portion A 20 presses and restrains laminate 7 between stripper 13 and side pad 17, but does not completely fix laminate 7. For example, laminate 7 may be easily movable by a force applied in an in-plane direction perpendicular to the pressing direction. The same applies to laminate restraining portions B and C appearing later.

In FIG. 5(c), punch die 12 is further lowered, stripper 13 and stripper drive mechanism 9 are moved, punch die 12 and pad 15 support laminate 7 in the vertical direction (Z direction), and laminate restraining portion B 21 for pressing laminate 7 is generated.

In FIG. 5(d), laminate restraining portion C 22, which supports and presses a vicinity of an end surface of laminate 7 between punch die 12 and side pad 17, is generated. Furthermore, punch die 12, stripper 13, and stripper drive mechanism 9 are moved, and laminate 7 is deformed from the two-dimensional shape to the three-dimensional shape by punch die 12. At this time, side pad 17 is pressed via laminate 7 by movement of punch die 12, and retracts in the horizontal direction (X direction). At this time, laminate 7 is restrained with an advancing force applied by side pad drive mechanism 18 by punch die 12 and side pad 17.

In FIG. 5(e), laminate restraining portion A 20 by stripper 13 and stripper drive mechanism 9 is eliminated. This is because when punch die 12 is further moved vertically downward (−Z direction), the end surface of laminate 7 is separated from the upper surface of side pad 17, and laminate 7 is drawn between punch die 12 and die 14. In the press molding die according to the first exemplary embodiment, as illustrated in FIG. 5(e), side pad 17 and side pad drive mechanism 18 are arranged. Thus, even when the end surface of laminate 7 is separated from the upper surface of side pad 17, laminate restraining portion B 22 that supports and presses laminate 7 in the horizontal direction can be provided at a position continuous from the end surface of the laminate. That is, laminate restraining portion A 20 by stripper 13 and stripper drive mechanism 9 and laminate restraining portion B 22 by side pad 17 and side pad drive mechanism 18 can be continuously provided. As a result, even when the end surface of laminate 7 is separated from the upper surface of side pad 17, laminate restraining portion B 22 by side pad 17 and side pad drive mechanism 18 can continuously support and press the vicinity of the end surface of laminate 7, so that laminate 7 can be suppressed from being excessive and wrinkled.

Note that restraint of laminate 7 by stripper 13 and stripper drive mechanism 9 and restraint of laminate 7 by side pad 17 and side pad drive mechanism 18 only needs to be performed by lightly pressing laminate 7 to such an extent that laminate 7 slides. For example, in a cloth in which the decorative layer of the laminate has a thickness of about 0.4 mm, a restraining force per one side pad and on one side of the slipper may be less than 20 kg. Further, when the decorative layer of the laminate is leather, the restraining force may be about 50 kg.

FIG. 5(f) is a diagram when punch die 12 is lowered to a bottom dead center. Thus, laminate 7 is shaped to be the shaped article. At this time, by designing projection allowance 19 of side pad 17 from die 14 to be zero when reaching the bottom dead center, that is, to be a position corresponding to the product shape so as to coincide with the surface of die 14, the product shape of the shaped article is not affected even when side pad 17 is provided. At the time illustrated in FIG. 5(f), laminate 7 is not present on the upper surface of die 14. In addition, at this time, the end portion of laminate 7 is present within a range of an inner side (laminate restraining portion B 22) of side pad 17.

FIG. 5(g) and 5(h) are diagrams illustrating two patterns when laminate 7 is taken out after the preform step. In FIG. 5(g), side pad 17 and side pad drive mechanism 18 are in a state where projection allowance 19 of side pad 17 from die 14 is zero, that is, in the product shape position until taken out in FIG. 5(f), which is convenient for taking out shaped laminate 7. However, in a case where drive mechanism 18 of side pad 17 is a spring, it is necessary to maintain projection allowance 19 of side pad 17 from die 14 at zero and add a mechanism capable of advancing again in FIG. 5(a) in the next process, and the die is complicated. In the case of hydraulic pressure or pneumatic pressure, a position of side pad 17 can be adjusted by, for example, attenuating the pressure, but control or a valve for attenuating the pressure is required.

FIG. 5(h) is a schematic sectional view illustrating a case where side pad 17 returns to the same position as FIG. 5(a) in accordance with driving of punch die 12. In this case, since mechanical structure, control, and valve are not required, complexity of the die is simpler than that in FIG. 5(g), but it is disadvantageous for taking out laminate 7. In addition, since laminate 7 is side-restrained by side pad 17 and punch die 12 until punch die 12 returns to the same position as in FIG. 5(a), shaping shape of laminate 7 may collapse from the product shape in FIG. 5(f). However, since risk of collapse of the shaping shape is determined by a relationship between the product shape and an amount of projection allowance 19 of the side pad from the die, both of FIG. 5(g) and 5(h) can be used on a case-by-case basis.

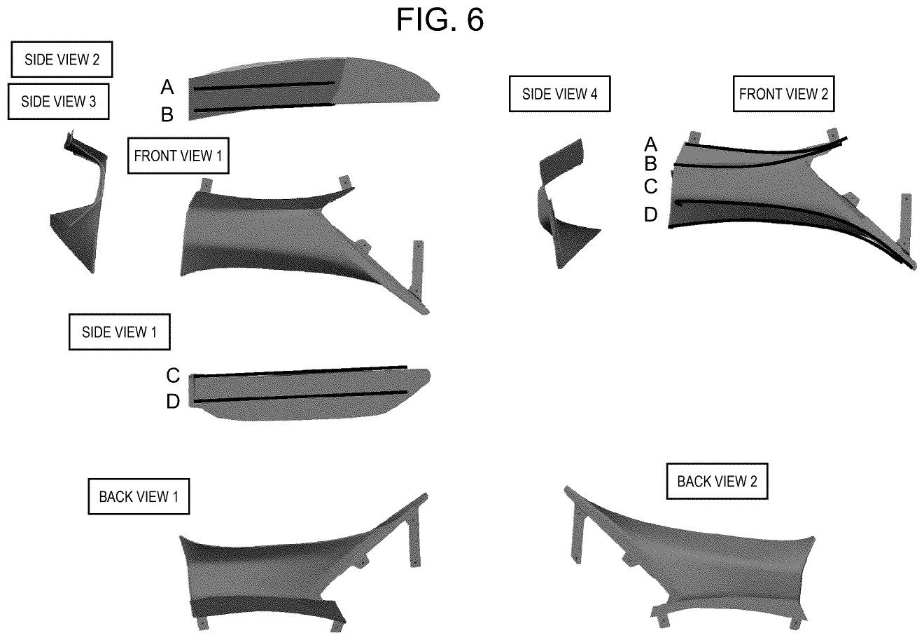

In FIG. 6, a shape of an example of the shaped article obtained using the press molding die according to the first exemplary embodiment will be described. FIG. 6 is a view illustrating a front view, a back view, and a plurality of side views of laminate 7 of the shaped article. This shape is a shape in which front view 1 is a product front view and has a convex shape with a 3D curved surface. In front view 2, four types of curves A, B, C, and D from an upper side of the figure of this product are described for the sake of explanation. Curves A and B are seen in side view 2, curve C is the upper side of the convex shape of the product, and curve D is the lower side of the convex shape of the product. Curves C and D are seen in side view 1, curve C is the upper side of the convex shape of the product, and curve D is the lower side of the convex shape of the product.

As described above, when curves A, B, C, and D have a shape in which an arc is drawn from an end to a vicinity of a center of the product, the laminate at both ends in a product longitudinal direction is deformed into a 3D shape while being deformed with movement in a product center direction as passing through FIG. 5(d) to 5(f). This movement in the product center direction causes the wrinkle. The wrinkle appears larger on curves C and D side than on curves A and B side. This is because curves C and D have smaller curvatures than curves A and B. In the present first exemplary embodiment, side pad 17 and side pad drive mechanism 18 regulate this movement.

A phenomenon in which the wrinkle occurs will be described with reference to FIG. 2. FIG. 2(a) to 2(d) are perspective views obtained by imaging by analysis the appearance of the intermediate component and the shaped article obtained in each step of the method for manufacturing the shaped article as described above.

FIG. 2(a) is laminate 7 at the time of FIG. 5(c), and has a 2D shape. FIG. 2(b) is laminate 7 at the time of FIG. 5(d), and laminate 7 is deformed into a 3D shape by punch die 12. FIG. 2(c) is laminate 7 at the time of FIG. 5(e). FIG. 2(d) is a perspective view illustrating an analysis result of intentionally fixing projection allowance 19 of the side pad from the die to zero from FIG. 5(a) to 5(e) instead of the press molding die according to the first exemplary embodiment. That is, this is a result of an analysis performed in a state where movement of the laminate described above in the product center direction is not restricted by side pad 17 and side pad drive mechanism 18. As illustrated in FIG. 2(d), the wrinkle toward the center can be imaged, and an effect can be confirmed.

### <Press Molding Die>

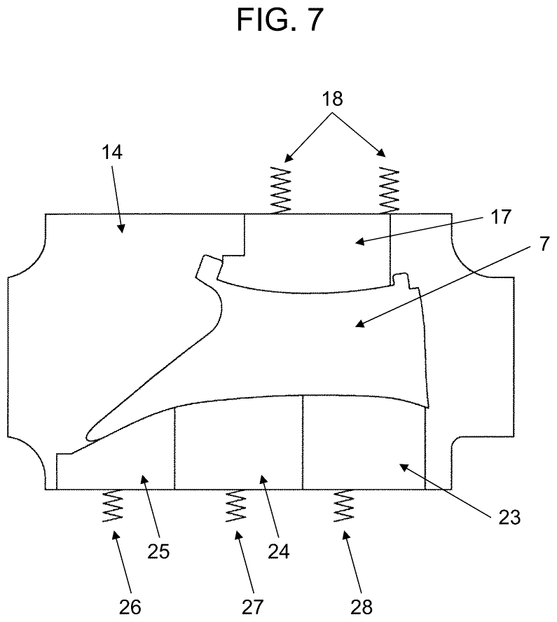

FIG. 7 is a plan view illustrating a front view of the press molding die including die 14, side pad 17, and side pad drive mechanism 18 in the method for manufacturing the shaped article of FIG. 2. Note that the same members as those in FIG. 5 are denoted by the same reference numerals, and description thereof will be omitted. Arrangement of the side pad is designed in consideration of a length and a curvature of the product, and flexibility of laminate 7. For example, as illustrated in FIG. 7, one side pad 17 is disposed on one side with respect to the curvature of the product on the upper side. On the other hand, since the curvature of the product on the lower side in FIG. 7 is smaller than the curvature of the product on the upper side and the length of the product on the lower side is longer than the length of the product on the upper side, three of side pad A 23, side pad B 24, and side pad C 25 are arranged instead of one side pad. In this way, the side pad may be divided into two or more parts and arranged. By performing division as illustrated in FIG. 7, since restraining forces of side pad drive mechanism A 26, side pad drive mechanism B 27, and side pad drive mechanism C 28 can be made independent of each other, so that adjustment is facilitated. That is, in one side pad, there is substantially one point in contact with the laminate, and it is difficult to uniformly constrain the laminate over a long curve, and by dividing the side pad into a plurality of side pads, the laminate can be constrained at a plurality of points, the restraint is stabilized, and generation of the wrinkle can be further suppressed.

### <Side Pad Drive Mechanism>

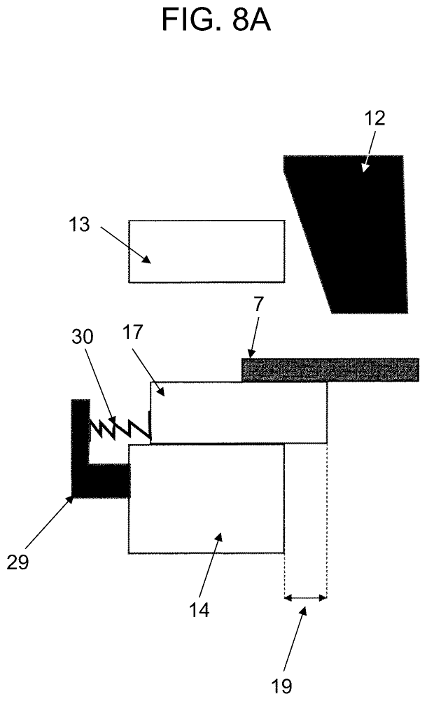

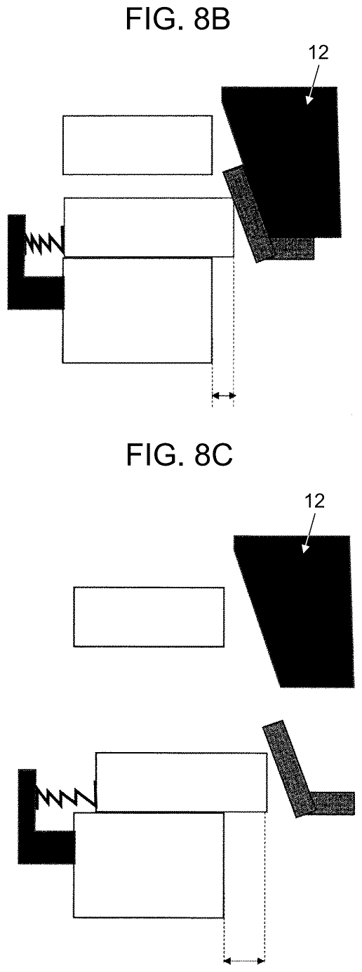

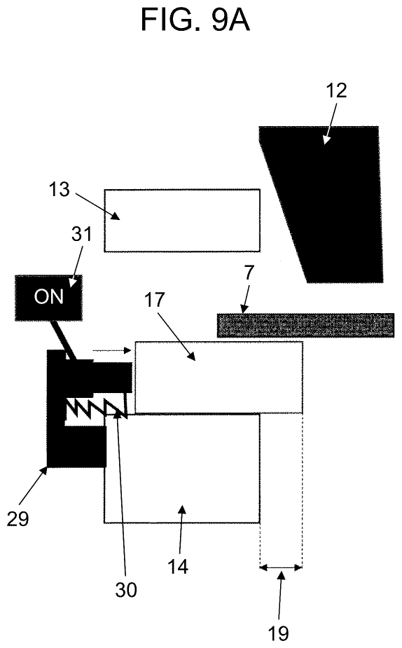

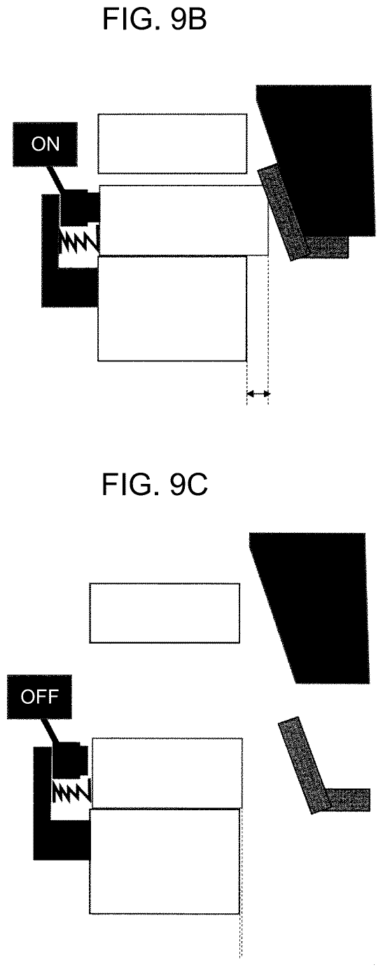

The side pad drive mechanism will be described with reference to FIGS. 8A to 8C and 9A to 9C. Note that, in FIGS. 8A to 8C and 9A to 9C, an outline of each member is linearly illustrated for convenience, but this does not mean that an outer shape of each member is linear or planar. Each member may be curved or may have a curved surface.

In FIGS. 8A to 8C, a method of driving the side pad using the spring will be described. Note that the same members as those in FIG. 5 are denoted by the same reference numerals, and description thereof will be omitted.
(1) FIG. 8A illustrates a part of FIG. 5(a) in detail. A metal spring or a gas spring may be used as spring 30 which is a specific example of side pad drive mechanism 18. Receiving plate 29 of the side pad drive mechanism has a function of fixing die 14 and spring 30.
(2) FIG. 8B illustrates a part of FIG. 5(e) in detail. As punch die 12 moves, while side pad 17 retracts, and projection allowance 19 of side pad 17 from die 14 decreases from that in FIG. 8A, punch die 12 is lowered to the bottom dead center while restraining laminate 7 by a reaction force of spring 30, that is, an advancing force of side pad 17.
(3) FIG. 8C illustrates a part of FIG. 5(h) in detail. When side pad 17 returns to the same position as that in FIG. 8A, projection allowance 19 of side pad 17 from die 14 is equal to that in FIG. 8A. Note that the advancing force of side pad 18 can be adjusted by changing a spring coefficient of spring 30.

In FIGS. 9A to 9C, the method of driving the side pad using the spring and a cylinder will be described. Note that the same members as those illustrated in FIG. 5 are denoted by the same reference numerals, and description thereof will be omitted.
(1) FIG. 9A illustrates a part of FIG. 5(a) in detail. As cylinder 31 that is a specific example of side pad drive mechanism 18, a hydraulic cylinder or an air cylinder using gas may be used. Receiving plate 29 of the side pad drive mechanism has a function of fixing die 14, spring 30, and cylinder 31. Note that in FIG. 9A, cylinder 31 advances in an ON state, a driving force of cylinder 31 and a restoring force of the spring are set to be opposite, that is, in opposite directions, and a length of projection allowance 19 of side pad 17 from die 14 can be adjusted by spring 30 and cylinder 31.
(2) FIG. 9B illustrates a part of FIG. 5(e) in detail. As punch die 12 is lowered, while side pad 17 retracts, and projection allowance 19 of side pad 17 from die 14 decreases from that in FIG. 9A, punch die 12 is lowered to the bottom dead center while restraining laminate 7 by the advancing force of the cylinder.
(3) FIG. 9C illustrates a part of FIG. 5(g) in detail. By setting cylinder 31 to an OFF state at the timing when punch die 12 reaches the bottom dead center, since side pad 17 is in a state in which projection allowance 19 of side pad 17 from die 14 is shorter than a state of FIG. 9A by the reaction force of spring 30, laminate 7 after the preform is easily taken out. An advantage of driving side pad 17 using spring 30 and cylinder 31 is that the restraining force of laminate 7 can be adjusted by adjusting the advancing force at an arbitrary timing when punch die 12 is lowered toward the bottom dead center in FIG. 9B. On the other hand, there is a disadvantage that it is necessary to control timing of the advancing force of the cylinder, which is more expensive than configuring side pad drive mechanism 18 only with spring 30 of FIGS. 8A to 8C.

### <Shape and Position of Side Pad>

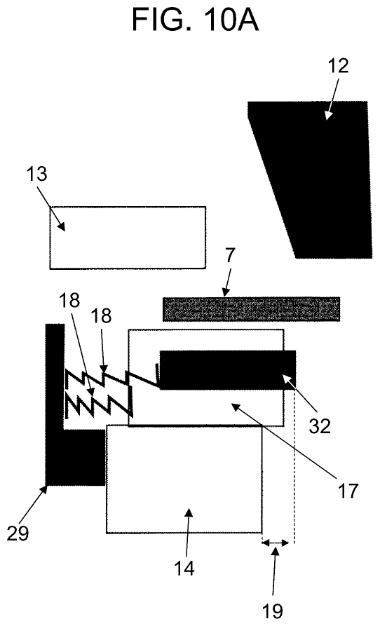

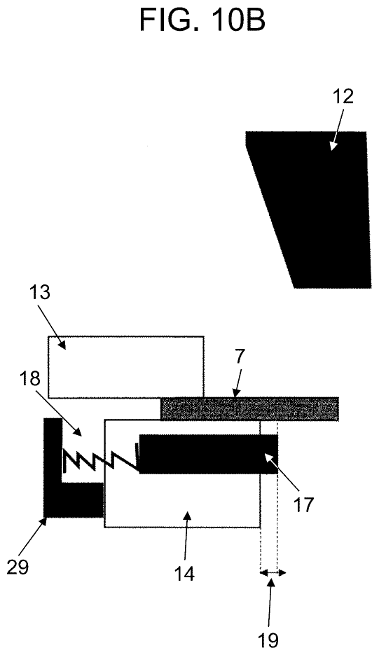

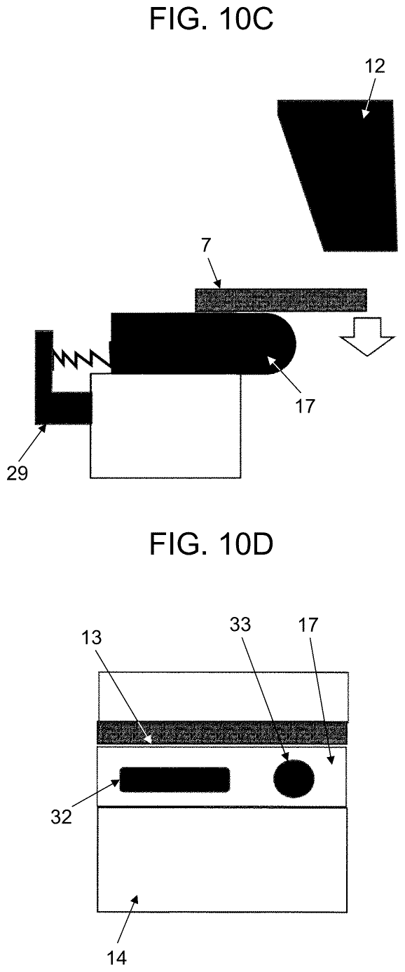

FIGS. 10A to 10D are schematic sectional views illustrating the shape and the position of the side pad in the press molding die according to a modification of the first exemplary embodiment. Note that the same members as those illustrated in FIG. 5 are denoted by the same reference numerals, and description thereof will be omitted. Further, in FIGS. 10A to 10D, the outline of each member is linearly illustrated for convenience, but this does not mean that the outer shape of each member is linear or planar. Each member may be curved or may have a curved surface.
(1) As illustrated in FIG. 10A, the side pad may be multistage in the vertical direction (thickness direction) like side pad 17 and side pad D 32 included in side pad 17. By adopting a multistage structure, the restraining force of laminate 7 can be locally increased while laminate 7 is entirely restrained by side pad 17.
(2) Side pad 17 may be included in die 14 as illustrated in FIG. 10B. By including side pad 17 in die 14, a thickness of die 14 can be reduced, and the handleability at the time of replacement of die 14 is increased.
(3) In FIG. 10C, the shape of side pad 17 will be described. FIG. 10C is a schematic sectional view of die 14. Since laminate 7 is drawn in a direction of an arrow as punch die 12 is lowered, a corner of side pad 17 is preferably R2 mm or more as illustrated in FIG. 10C.
(4) FIG. 10D is a view of side pad 27 and side pad D 32 as viewed from a drive direction. As illustrated in FIG. 10D, the side pad may also have a rectangular shape with a corner of R2 mm or more, or may be columnar side pad E 33 with a tip of R2 mm or more.

### <Insert Molding>

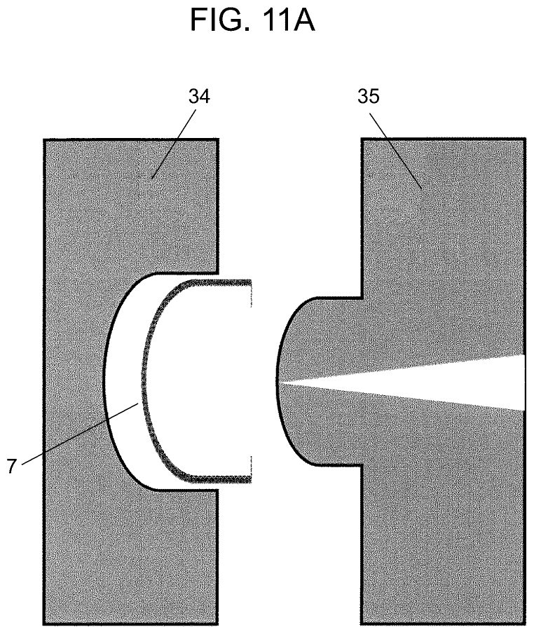

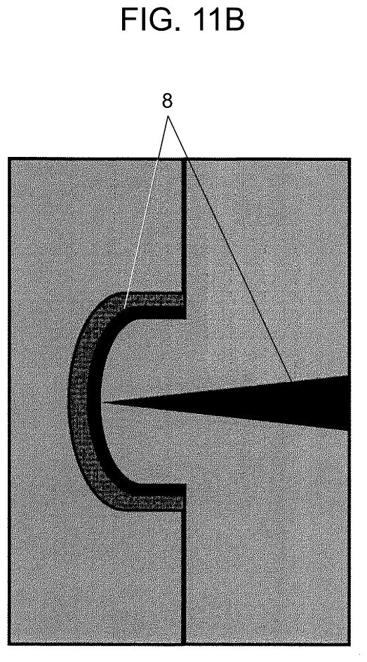

FIGS. 11A and 11B are schematic sectional views illustrating a sectional structure in each step of insert molding that is an example of the method for manufacturing the molded article according to the first exemplary embodiment. The insert molding is performed as follows.
(1) Laminate 7 after the preform described above is disposed between cavity die 34 and core die 35, which are injection molding dies (FIG. 11A).
(2) Cavity die 34 and core die 35 are clamped.
(3) Injection molding resin 8 is injected into a cavity defined between a rear surface of laminate 7 placed on cavity die 34 and core die 35 (FIG. 11B).
(4) After injection molding resin 8 is cured, the cavity die and the core die are opened, and the molded article formed of the shaped article and the cured resin is taken out.

Through the above steps, the decorative component that is the molded article can

### Second Exemplary Embodiment

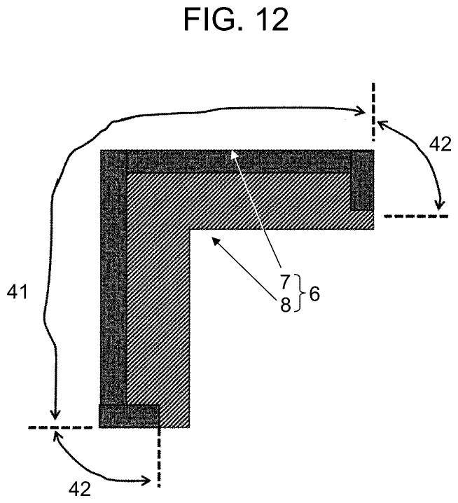

A second exemplary embodiment is different from the first exemplary embodiment in that laminate 7 is disposed up to a part of a rear surface of the decorative component. FIG. 12 is a schematic sectional view illustrating a primary appearance surface and a secondary appearance surface which are normal appearance surfaces of the decorative component which is the molded article according to the second exemplary embodiment. Note that the same members as those in FIG. 1 are denoted by the same reference numerals, and description thereof will be omitted.

As illustrated in FIG. 12, decorative component 6 has appearance surface (primary appearance surface) 41 and secondary appearance surface 42, and the secondary appearance surface refers to a surface that cannot be seen unless intentionally gazed. In general, when injection molding resin 8 constituting the rear surface of the decorative component is visible even at a location of secondary appearance surface 42, the decorative component will appear less luxurious and elegant. Therefore, it is often necessary for laminate 7 to cover up to secondary appearance surface 42. The secondary appearance surface often corresponds to the undercut in the die, and it is necessary to provide the undercut in the shaping (preform) step. On the other hand, when the undercut is present, it is necessary to form a movable structure called a slide in the die in order to release shaped laminate 7 from the die.

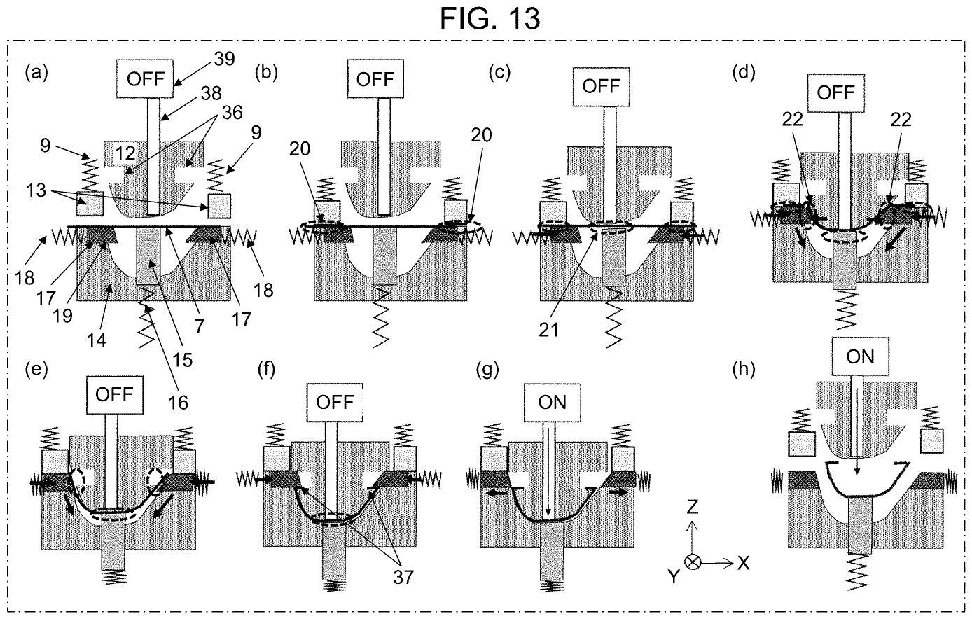

FIG. 13 is a schematic sectional view illustrating the steps of the method for manufacturing the shaped article using the press molding die according to the second exemplary embodiment. A configuration for using the side pad also as the slide will be described with reference to FIG. 13. Note that the same members as those in FIG. 5 are denoted by the same reference numerals, and description thereof will be omitted. As an additional point from FIG. 5, the press molding die according to the second exemplary embodiment is different from the first exemplary embodiment in that punch die side undercut processing 36, laminate undercut 37, air supply path 38 (sometimes referred to as gas supply path 38), and compressed air supply machine 39 are added.

As illustrated in FIG. 13(a), the press molding die according to the second exemplary embodiment is provided with punch die side undercut processing 36 in punch die 12, air supply path 38 for releasing laminate 7 from punch die 12, and compressed air supply machine 39 for supplying air through air supply path 38. Punch die side undercut processing 36 has a recessed shape provided in punch die 12, and is designed to store side pad 17 and laminate 7, and is therefore designed to be at least about 0.2 mm larger than a thickness of side pad 17 and laminate 7, and in terms of a depth direction of the recess, it is designed to be at least 0.5 mm deeper than when side pad 17 advances most. Note that air supply path 38 may use a gas other than air in order to release laminate 7 from punch die 12. Examples of the gas other than air include carbon dioxide, argon, oxygen, and nitrogen.

In FIG. 13(a) to 13(e), since the steps proceed in the same order as in FIG. 5(a) to 5(e), description thereof will be omitted.

In FIG. 13(f), laminate undercut 37 is formed. When punch die 12 reaches the bottom dead center, side pad 17 advances toward a space of punch die side undercut processing 36. While laminate 7 is restrained by laminate restraining portion B 21 when side pad 17 advances, laminate 7 in contact with side pad 17 is drawn into punch die side undercut processing 36 along with advancement of the side pad, and thus laminate undercut 37 is formed.

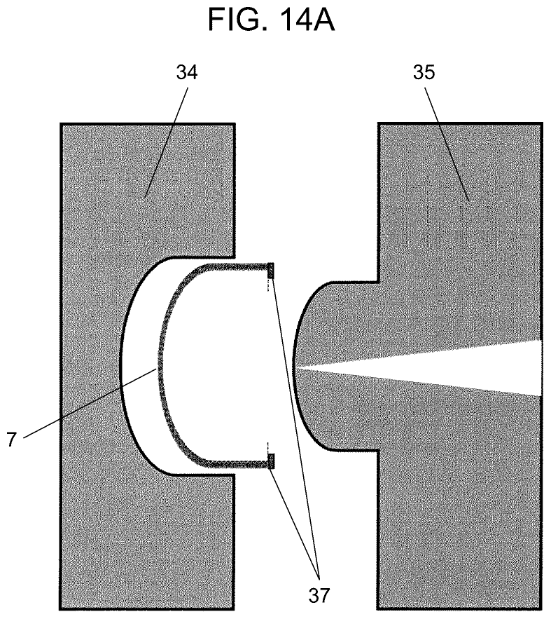

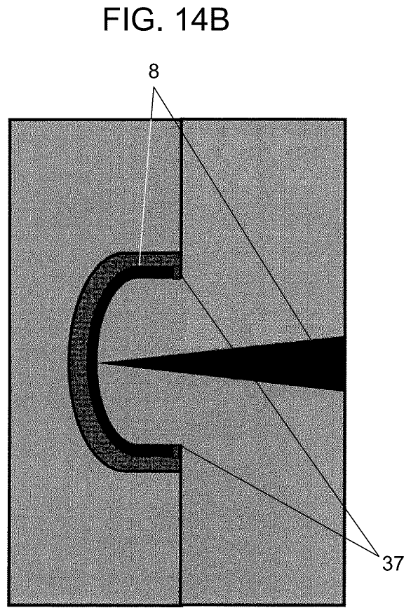

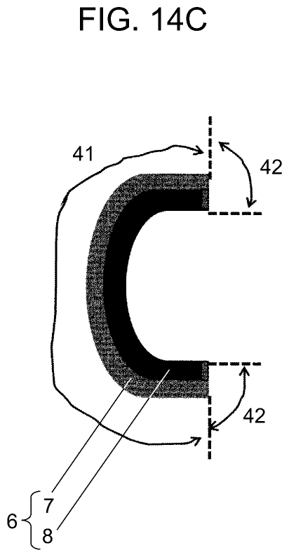

In FIG. 13(g), side pad 17 is retracted by side pad drive mechanism 18 to a position that does not prevent punch die 12 from being released from die 14. At this time, since laminate 7 is not released from punch die 12 by laminate undercut 37, release of laminate 7 is promoted by flowing air from compressed air supply machine 39 through air supply path 38, and it is possible to obtain laminate 7 provided with laminate undercut 37 in FIG. 13(h). By using laminate 7 and undergoing the injection molding step as in FIGS. 14A to 14C, it is possible to obtain decorative component 6 which is the molded article in which laminate 7 is present not only on appearance surface (primary appearance surface) 41 but also on secondary appearance surface 42 as illustrated in FIG. 14C. Note that, in FIGS. 14A to 14C, the same components as those in FIGS. 12 and 13 are denoted by the same reference numerals, and description thereof will be omitted.

### <Drive Mechanism of Side Pad>

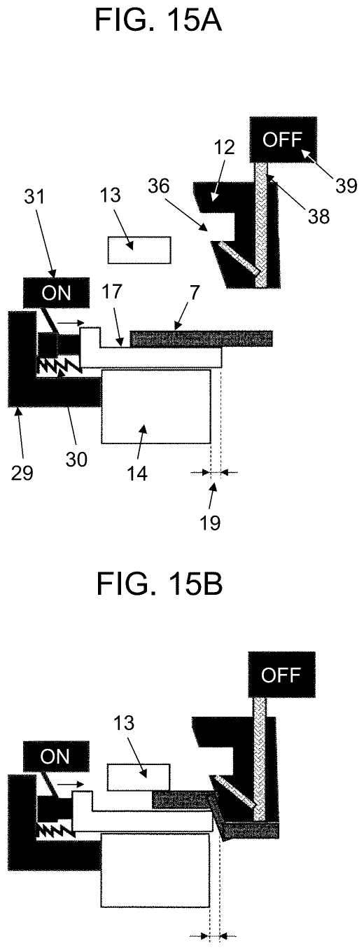

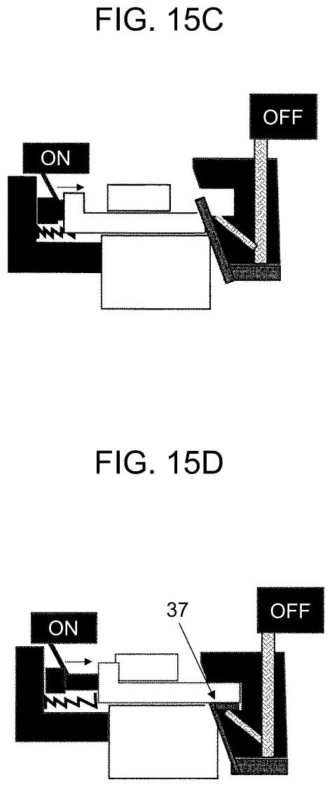

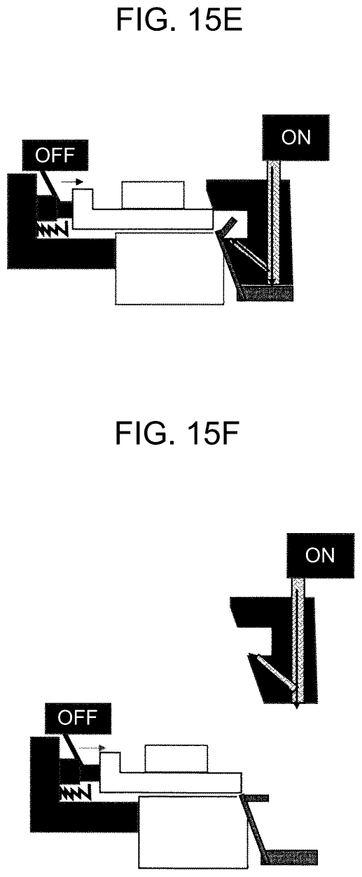

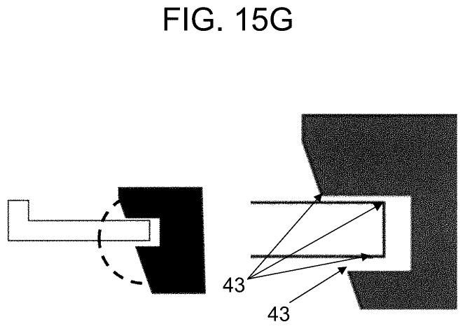

Next, a drive mechanism of side pad 17 in the press molding die according to the second exemplary embodiment will be described with reference to FIGS. 15A to 15G. The same members as those in FIGS. 9A to 9C are denoted by the same reference numerals, and description thereof will be omitted. Note that in FIGS. 15A to 15G, the outline of each member is linearly illustrated for convenience, but this does not mean that the outer shape of each member is linear or planar. Each member may be curved or may have a curved surface.

FIG. 15A illustrates a part of FIG. 13(a) in detail. Punch die 12 is provided with punch die side undercut processing 36, air supply path 38, and compressed air supply machine 39.

FIG. 15B illustrates a part of FIG. 13(b) in detail. As punch die 12 is lowered, side pad 17 is pushed down, but laminate 7 is deformed while being restrained by the restraining force corresponding to the reaction force of the cylinder by the reaction force of cylinder 31. In addition, laminate 7 is also restrained by a certain restraining force by being set between stripper 13 and side pad 17.

FIG. 15C illustrates a part of FIG. 13(e) in detail. As punch die 12 is further lowered, laminate 7 moves to a position where laminate 7 is detached from stripper 13. At this time, laminate 7 is deformed while being restrained by a horizontal restraining force corresponding to the advancing force of cylinder 31 between side pad 7 and punch die 12. Note that also in this case, as in the first exemplary embodiment, even after the end surface of the laminate is detached from stripper 13, laminate 7 is continuously supported and pressed between side pad 7 and punch die 12, and is restrained.

FIG. 15D illustrates a part of FIG. 13(f) in detail. At this time, punch die 12 is lowered to a position of the bottom dead center, and by adjusting an advanced position of the cylinder so that side pad 17 is stored in punch die side undercut processing 36 provided in punch die 12 in a height direction, laminate undercut 37 can be formed.

FIG. 15E illustrates FIG. 13(g) in detail. Side pad 17 is retracted in a state where punch die 12 is at the bottom dead center. Then, air is supplied from compressed air supply machine 39 through air supply path 38 so that laminate undercut 37 can be smoothly released from punch die 12. Air supply path 38 may be provided at multiple locations. For example, by providing air supply path 38 at a position in contact with laminate undercut 37 in punch die side undercut processing 36, laminate undercut 37 is easily released from punch die 12. Note that air supply path 38 has a tubular shape or a slit shape.

FIG. 15F illustrates FIG. 13(h) in detail. Side pad 17 is retracted to a position not hindering lowering of punch die 12.

FIG. 15G is an enlarged view of side pad 17 and punch die side undercut processing 36. In order to perform smooth driving, corner R 43 with R of 0.5 mm or more may be provided. However, in a case where punch die side undercut processing 36 is provided with corner R 43 with R of 0.5 mm or more, since the laminate undercut also has the same R, R of punch die side undercut processing 36 may be intentionally set to less than 0.5 mm.

Note that in the second exemplary embodiment, FIGS. 15A to 15G illustrate an example of the method of driving the side pad for forming the laminate undercut, and the plurality of side pads may be provided in the die as illustrated in FIGS. 9A to 9C.

### REFERENCE MARKS IN THE DRAWINGS

1: veneer
2: decorative layer
3: adhesive layer
4: support layer
5: substrate resin
6: decorative component
7: laminate
8: injection molding resin
9: stripper drive mechanism
10: female die
11: male die
12: punch die
13: stripper
14: die
15: pad
16: pad drive mechanism
17: side pad
18: side pad drive mechanism
19: projection allowance of side pad from die
20: laminate restraining portion A
21: laminate restraining portion B
22: laminate restraining portion C
23: side pad A
24: side pad B
25: side pad C
26: side pad drive mechanism A
27: side pad drive mechanism B
28: side pad drive mechanism C
29: receiving plate of side pad drive mechanism
30: spring
31: cylinder
32: side pad D
33: side pad E
34: cavity die
35: core die
36: punch die side undercut processing
37: laminate undercut
38: air supply path
39: compressed air supply machine
40: veneer/resin laminated structure housing
41: appearance surface
42: secondary appearance surface
43: corner R with R of 0.5 or more

1. A press molding die of at least one of a punch and a die, the press molding die comprising a support pressing mechanism that supports a workpiece at a position where the workpiece is not shaped during press processing, and presses the workpiece in a pressurizing direction.

2. The press molding die according to claim 1, further comprising a side pressing mechanism that supports the workpiece from a direction perpendicular to the pressurizing direction along with deformation of the workpiece during press processing, retracts to a surface continuous with a surface of the press molding die in contact with the workpiece in accordance with progress of shaping, and shapes the workpiece.

3. The press molding die according to claim 1, further comprising a plurality of the pressing mechanisms.

4. The press molding die according to claim 1, wherein the pressing mechanism has an undercut forming function of forming an undercut in the workpiece.

5. A press molding die set including a punch and a die, the press molding die set comprising the press molding die according to claim 1.

6. A press device comprising the press molding die set according to claim 5.

7. A method for manufacturing a shaped article, the method comprising:
a first step of placing a workpiece on a press molding die; and
a second step of pressing the workpiece with the press molding die to form the workpiece into the shaped article, wherein
in the second step, while supporting the workpiece at a position where the workpiece is not shaped and pressing the workpiece in a pressurizing direction, the workpiece is pressed to form the workpiece into the shaped article.

8. The method for manufacturing the shaped article according to claim 7, wherein in the second step, the workpiece is supported from a direction perpendicular to the pressurizing direction along with deformation of the workpiece, and the workpiece is shaped along a surface continuous with a surface of the press molding die in contact with the workpiece in accordance with progress of shaping.

9. The method for manufacturing the shaped article according to claim 7, further comprising an undercut forming step of forming an undercut in the workpiece.

10. A method for manufacturing a molded article, the method comprising:
a step of placing the shaped article obtained in claim 7 on a cavity die of an injection molding die including a cavity die and a core die, and clamping the cavity die and the core die;
a step of allowing a resin to flow into a cavity defined between the shaped article placed on the cavity die and the core die; and
a step of, after the resin is cured, opening the cavity die and the core die to take out a molded article made of the shaped article and the cured resin.

11. The press molding die according to claim 2, wherein an upper surface of the side pressing mechanism is an upper surface of the die.

12. The press molding die according to claim 4, wherein the punch has a gas supply path for supplying gas for releasing the workpiece.

13. The press molding die according to claim 12, wherein the gas supply path is in contact with an undercut of the workpiece.

14. The press molding die according to claim 13, wherein the gas supply path supplies gas to at least one of a lower portion of the punch and the undercut of the workpiece.

15. The method for manufacturing the shaped article according to claim 7, wherein in the second step, a support pressing mechanism that supports the workpiece at the position where the workpiece is not shaped and presses the workpiece in a pressurizing direction, and a side pressing mechanism that supports the workpiece from a direction perpendicular to the pressurizing direction along with deformation of the workpiece, retracts to a surface continuous with a surface of the press molding die in contact with the workpiece in accordance with progress of shaping, and shapes the workpiece are included, and the support pressing mechanism and the side pressing mechanism press the workpiece while sliding the workpiece.

16. The method for manufacturing the shaped article according to claim 7, wherein
the press molding die includes a punch,
the punch has a gas supply path for supplying gas for releasing the workpiece, and
the gas supply path supplies the gas to at least one of a lower portion of the punch and an undercut of the workpiece.
